(19) United States
(12) Patent Application Publication
(10) Pub. No.: US 2008/0120684 A1
(43) Pub. Date: May 22, 2008

(54) Method and System for Upgrading Distributed Set Top Box and Device thereof

(75) Inventor: Tao Yang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzen (CN)

(21) Appl. No.: 11/940,629

(22) Filed: Nov. 15, 2007

(30) Foreign Application Priority Data
Nov. 17, 2006 (CN) 200610138485.6

(51) Int. Cl. H04N 7/16

(52) U.S. Cl. 725/152

(57) ABSTRACT

A method for upgrading a distributed Set Top Box (STB) from a central node upgrade management device is disclosed by the present invention. The method includes the following steps: receiving an STB upgrade request sent by a user terminal; selecting a device upgrade address of an edge node; and sending the device upgrade address of the edge node to the user terminal. The present invention further discloses a system for upgrading distributed STB, a central node upgrade management device, an edge node in a system for upgrading a distributed STB, a user terminal, a computer program product and a computer readable medium. The upgrade of the distributed STB in the IPTV architecture is implemented in accordance with the present invention, which reduces the pressure of the upgrade of the STB on the backbone/convergence network, and greatly improves the response speed and reliability of the upgrade of the STB.

### FIELD OF THE INVENTION

The present invention relates to Internet Protocol Television (IPTV) technology, and more particularly, to a method and system for upgrading distributed Set Top Box (STB), devices thereof, computer program product and computer readable medium.

### BACKGROUND OF THE INVENTION

At present, the large-scale software upgrade of devices such as STB is a problem for a lot of user terminals. Because during the software upgrade, the action of a user is uncontrollable, a lot of STBs often request the software upgrade simultaneously, which occupies too much master network bandwidth and has a great impact on the services and the IPTV system. Therefore, it is necessary to provide a solution to solve the abovementioned problem.

FIG. 1 is a schematic diagram illustrating a typical deployment of the function modules and system in an IPTV application architecture. Referring to FIG. 1, the system for managing the upgrade of the STB has a centralized deployment in the IPTV application architecture, i.e. the whole STB upgrade management system is deployed at a central node of network. The reliability and load balance of the system are implemented by deploying an L4/L7 load balancing device at a front end. The above mentioned deployment method is applicable to small areas when the user terminals are of a small scale, but has the following disadvantages when it's applied to large areas and distributed areas.

Referring to FIG. 1, because the STB upgrade management system is deployed at the centre of the network as shown by the dashed line, all STB upgrade traffics pass through the backbone/convergence network during the software upgrade of the STB, which increases the load pressure for the backbone/convergence network. In addition, the STB upgrade management system is unable to provide a convenient service according to the user location, which may lead to delay in response and may increase the upgrade unreliability. At last, all of the STB upgrade management system is deployed at the central node, which blocks the whole system to implement high availability; and the L4/L7 load balancing device of the front end will be a bottleneck of performance, it is not adapt to the situation of large-scale users.

### SUMMARY OF THE INVENTION

A method for upgrading a distributed STB from a central node upgrade management device is provided by the present invention. The method includes the following steps:

receiving an STB upgrade request sent by a user terminal;

selecting a device upgrade address of an edge node; and

sending the device upgrade address of the edge node to the user terminal.

A system for upgrading distributed STB is also provided by the present invention. The system includes a central node upgrade management device and at least one edge node. And the central node upgrade management device is configured for selecting an device upgrade address of an edge node and sending out the device upgrade address of the edge node to a user terminal upon receiving an STB upgrade request from the user terminal. The edge node is configured for sending information stored for upgrading an STB to the user terminal upon receiving an upgrade request sent by the user terminal according to the device upgrade address of the edge node.

A central node upgrade management device is further provided by the present invention. The central node upgrade management device includes: a first unit, configured to receive an STB upgrade request from a user terminal;

a second unit, configured to select a device upgrade address of an edge node; and

a third unit, configured to send the device upgrade address of the edge node to the user terminal.

An edge node in a system for upgrading a distributed STB is also provided by the present invention. The edge node is configured to receive a STB update request from a user terminal to a device upgrade address of the edge node, and to send the STB user information to the user terminal.

A user terminal with an STB, configured to send a request for STB upgrade information to a central upgrade management system, is also provided by the present invention. The user terminal is configured to receive a device upgrade address to an edge node from the central upgrade management system, send the STB upgrade request to the device upgrade address, and receive the STB upgrade information from the edge node.

The present invention also provides a computer program product. The computer program product includes computer program code, which, when it is executed by a computer unit, will cause the computer unit to perform the steps of the above mentioned user terminal.

The present invention also provides a computer readable medium which stores computer program code mentioned in the above computer program product.

The present invention has the following advantages.

The distributed STB upgrade management system is deployed at each edge node close to a user terminal, and the traffic produced by the STB upgrade does not need to pass through the backbone/convergence network. So the pressure of the upgrade of the STB on the backbone/convergence network is reduced, and the response speed and reliability of the upgrade of the STB is greatly improved.

### BRIEF DESCRIPTION OF THE DRAWINGS

FIG. 1 is a schematic diagram illustrating the centralized deployment of STB upgrade management system in the IPTV application architecture of the prior art.

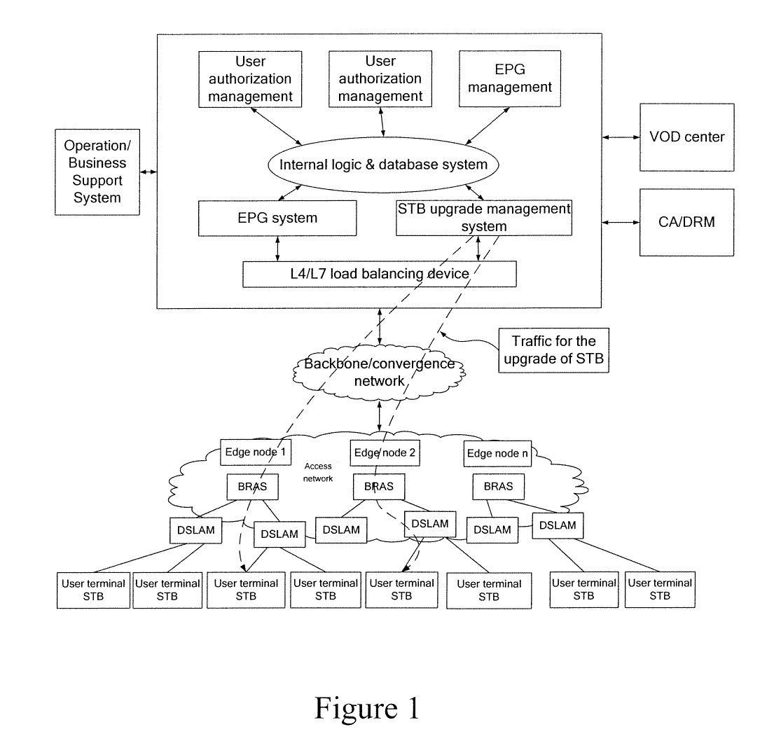

FIG. 2 is a schematic diagram illustrating a structure of distributed STB upgrade management system in accordance with a first embodiment of the present invention.

FIG. 3 is a schematic diagram illustrating a structure of distributed STB upgrade management system in accordance with a second embodiment of the present invention.

FIG. 4 is a flowchart illustrating a distributed STB upgrade management method in accordance with a third embodiment of the present invention.

FIG. 5 is a schematic diagram illustrating a distributed STB upgrade management method in accordance with a forth embodiment of the present invention.

FIG. 6 is a flowchart illustrating a distributed STB upgrade management method in accordance with the forth embodiment of the present invention.

FIG. 7 is a schematic diagram illustrating a distributed STB upgrade management method in accordance with a fifth embodiment of the present invention.

FIG. 8 is a flowchart illustrating a distributed STB upgrade management method in accordance with the fifth embodiment of the present invention.

### DETAILED DESCRIPTION OF THE INVENTION

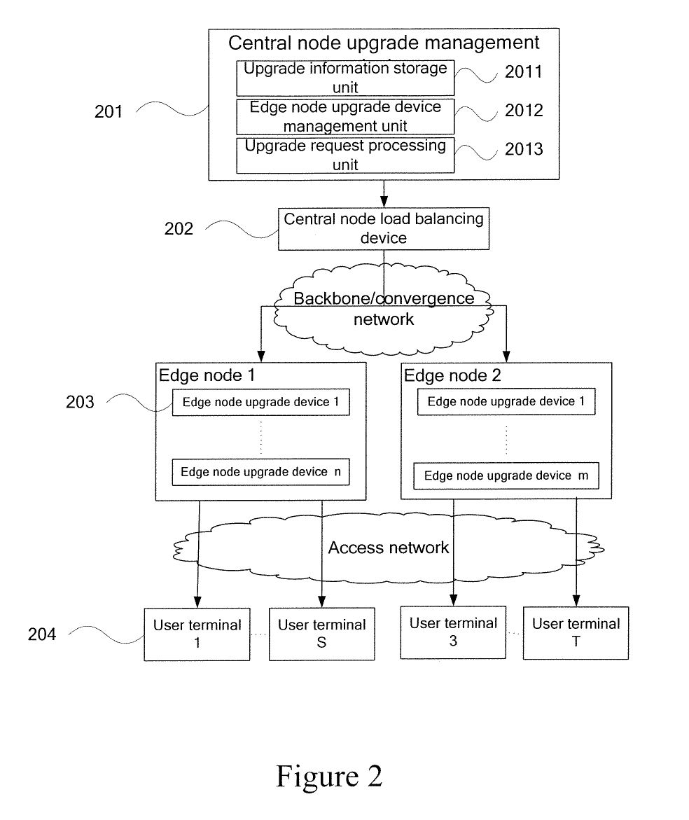

In accordance with an embodiment of the present invention, the distributed STB upgrade management system may deploy one or multiple edge nodes in a network according to the distribution of user terminals, and deploy one or multiple upgrade devices at each edge node. The number of edge nodes and upgrade devices may be adjusted according to the number of user terminals. If two edge nodes are deployed in the distributed STB upgrade management system, and multiple edge node upgrade devices are respectively deployed under the two edge nodes, a first embodiment of the present invention is hereinafter described. As shown in FIG. 2, the distributed STB upgrade management system consists of a central node upgrade management device 201, a central node load balancing device 202, multiple edge node upgrade devices 203 under each edge node, and multiple user terminals 204.

The central node upgrade management device 201 resides in the central node of the network; the central node load balancing device 202 resides in the front end of the central node upgrade management device 201; a central Virtual IP (c-VIP) address is externally used by the central node upgrade management device 201. Each of the edge nodes is connected to a central node over a backbone/convergence network, and each of the edge nodes has multiple edge node upgrade devices 203. Each edge node has multiple user terminals 204 connected to the edge node via the access network.

The central node upgrade management device 201 is used for storing STB upgrade information, maintaining the device upgrade address and STB software information of each edge node upgrade device 203, selecting and sending the address of an optimized edge node upgrade management device as the device upgrade address to a user terminal 204, after receiving an STB upgrade request from the user terminal 204.

Referring to FIG. 2, the central node upgrade management device 201 further includes an upgrade information storage unit 2011, an edge node upgrade device management unit 2012 and an upgrade request processing unit 2013.

The upgrade information storage unit 2011 stores the newest STB software information.

The edge node upgrade device management unit 2012 manages the address of each edge node upgrade device, and updates the STB software information stored by each edge node upgrade device 203.

Upon receiving an STB upgrade request from the user terminal 204 according to the location information of the user terminal 204, the load condition and/or the operation condition of each edge node upgrade device provided by the central node load balancing device 202, the upgrade request processing unit 2013 selects and sends the address of an optimized edge node upgrade device to the user terminal 204. The standard for selecting an optimized edge node upgrade device includes: normal operation and the least load, or other preset strategies.

The central node load balancing device 202 manages the signalling interaction between the central node upgrade management device 201 and the external network, and obtains the load condition and/or the operation condition of each edge node upgrade device 203 periodically. The operation condition includes the network response time, CPU utilization factor, memory utilization factor, whether each of the hardware works well, whether each of the software works well, and whether the upgrade information is correct, etc.

The edge node upgrade device 203 resides at the edge of the network, and the edge node upgrade device 203 provides an adjacent user terminal with the information required for upgrade upon receiving an STB upgrade request from a user terminal.

The user terminal 204 includes an STB device, sends an upgrade request to the central node upgrade management device 201 during the upgrade of the STB, and receives the upgrade information sent by the edge node upgrade device 203.

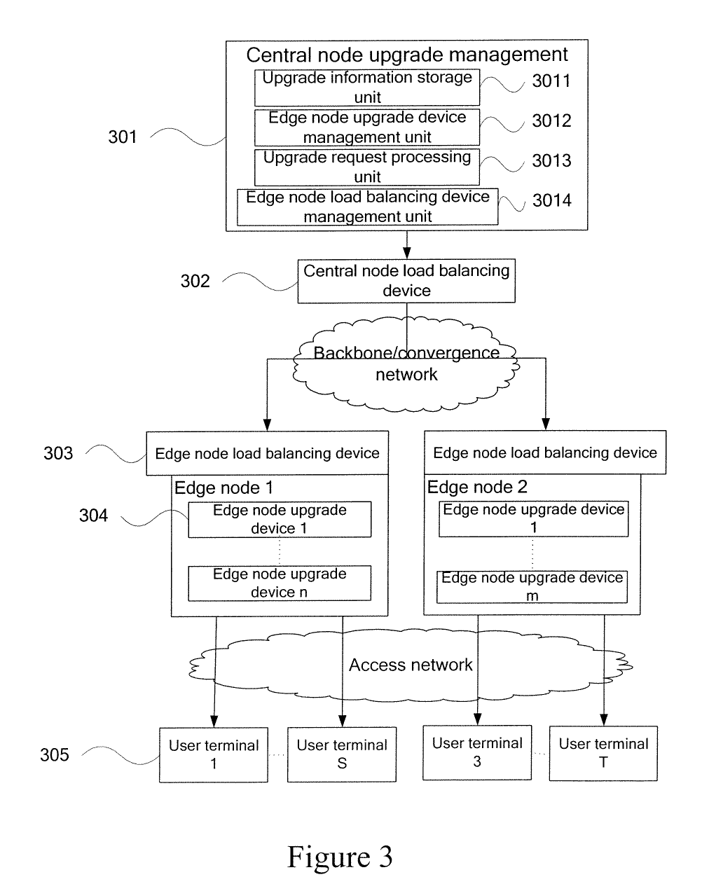

The system for upgrading distributed STBs in accordance with an embodiment of the present invention may also deploy one or multiple edge nodes in the network according to the distribution of user terminals, deploy one edge node load balancing device, and deploy one or multiple upgrade devices at each edge node; the number of edge nodes and the number of the upgrade devices may be adjusted according to the number of user terminals. A second embodiment of the present invention is hereinafter described, and in the second embodiment two edge nodes are deployed in the distributed STB upgrade management system; and one edge node load balancing device and multiple edge node upgrade devices are deployed under each of the two edge nodes. As shown in FIG. 3, the distributed STB upgrade management system includes a central node upgrade management device 301, a central node load balancing device 302, an edge node load balancing device 303 of each edge node, multiple edge node upgrade devices 304 and multiple user terminals 305.

In FIG. 3, the central node upgrade management device 301 resides in the central management node of the network, and the central node load balancing device 302 resides in the front end of the central node upgrade management device 301; a central Virtual IP (c-VIP) address is externally used by the central node upgrade management device 301. Each of the edge nodes is connected to the central node over the backbone/convergence network. Each of the edge nodes has one edge node load balancing device 303 using an edge Virtual IP (e-VIP) address, and multiple edge node upgrade devices 304. Each of the edge nodes has multiple user terminals 305 connected to the edge node over the access network.

The central node upgrade management device 301 stores the STB upgrade information, and maintains the address and STB software information of each edge node upgrade device 304 and the address of each edge node load balancing device 303; and sends the e-VIP address of the load balancing device 303 of the edge node adjacent to the user terminal to the user terminal 305 upon receiving an STB upgrade request from the user terminal 305.

Referring to FIG. 3, the central node upgrade management device 301 further includes an upgrade information storage unit 3011, an edge node upgrade device management unit 3012, an upgrade request processing unit 3013 and an edge node load balancing device management unit 3014.

The upgrade information storage unit 3011 stores the newest STB software information.

The edge node upgrade device management unit 3012 manages the device upgrade address of each edge node upgrade device 304, and updates the STB software information stored by each edge node upgrade device 304 periodically.

The upgrade request processing unit 3013 sends the e-VIP address of the load balancing device 303 of the edge node adjacent to the user terminal to the user terminal 305 according to the location information of the user terminal 305, after receiving an STB upgrade request from the user terminal 305;

The edge node load balancing device management unit 3014 manages the e-VIP address of the edge node load balancing device 303 under each edge node.

The central node load balancing device 302 manages the signalling interaction between the central node upgrade management device 201 and the external network.

The edge node load balancing device 303 manages the device upgrade address of each edge node upgrade device 304 under the same edge node, and obtains the load condition and the operation condition of each edge node upgrade device 304 periodically. The operation condition includes the network response time, CPU utilization factor, memory utilization factor, whether each of the hardware works well, whether each of the software works well, and whether the upgrade information is correct, etc. The edge node load balancing device 303 selects an optimized edge node upgrade device to upgrade the STB of the user terminal 305 after receiving an STB upgrade request sent by the user terminal 305. The standard for selecting an optimized edge node upgrade device includes: normal operation and the least load, or other preset strategies.

The edge node upgrade device 304 resides at the edge of the network, and provides a user terminal with the information required for upgrade.

A user terminal 305 including an STB device sends an upgrade request to the central node upgrade management device 301 during the upgrade of the STB, and receives the upgrade information sent by the edge node upgrade device 304.

The distributed STB upgrade management system, as shown in the first embodiment or the second embodiment, deploys an upgrade server at different edge nodes. For the STB upgrade requests sent by the user terminals residing in different locations, the central node upgrade management device or the edge node load balancing device selects the address of the different edge node upgrade devices as the device upgrade address, so that the traffic for the upgrade of the STB is obtained from the edge node upgrade device directly, and the pressure for the backbone/convergence network is greatly reduced. Further, the number of edge nodes and upgrade devices may be adjusted according to the number of user terminals, which improves the response speed and reliability of the upgrade of the STBs, and meets the requirement of application with large-scale users.

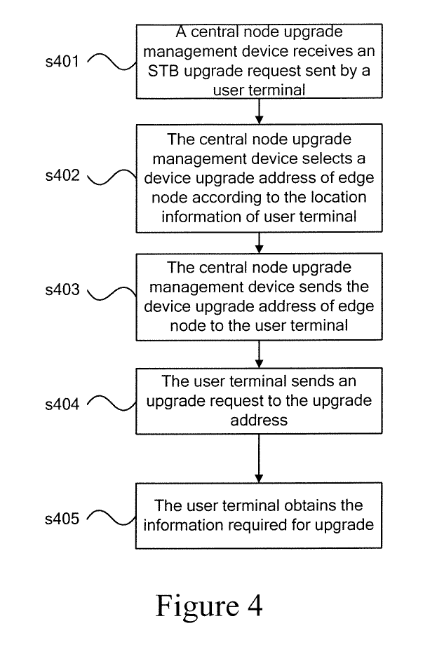

FIG. 4 is a flowchart illustrating a distributed STB upgrade management method in accordance with a third embodiment of the present invention. The third embodiment includes the following steps:

s401: A central node upgrade management device receives an STB upgrade request sent by a user terminal.

s402: The central node upgrade management device selects a device upgrade address of an edge node according to the location information of the user terminal.

s403: The central node upgrade management device returns the device upgrade address of the edge node to the user terminal.

s404: The user terminal sends an upgrade request to the device upgrade address.

s405: The user terminal obtains the information required for the upgrade.

In s402, there are two methods for the central node to select a device upgrade address of an edge node.

The first method: the central node upgrade management device obtains the load condition and/or the operation condition of each current edge node upgrade device by exchanging information with each edge node upgrade device periodically, selects the device upgrade address of an optimized edge node upgrade device as the device upgrade address of the edge node, and notifies the user terminal to communicate with the device upgrade address of the edge node. The distributed group of edge node upgrade management devices provides the high availability and load balancing. The standard for selecting an optimized edge node upgrade device includes: being close to the user terminal, normal operation with the least load, or other preset strategies.

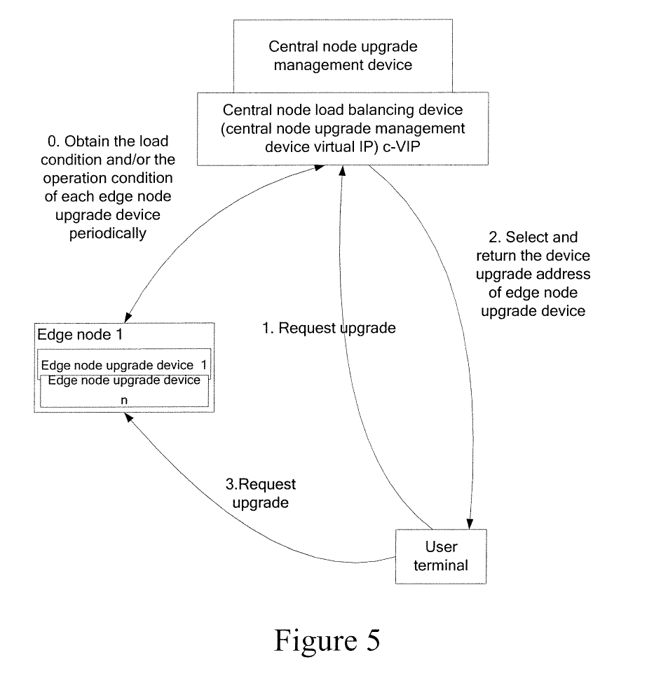

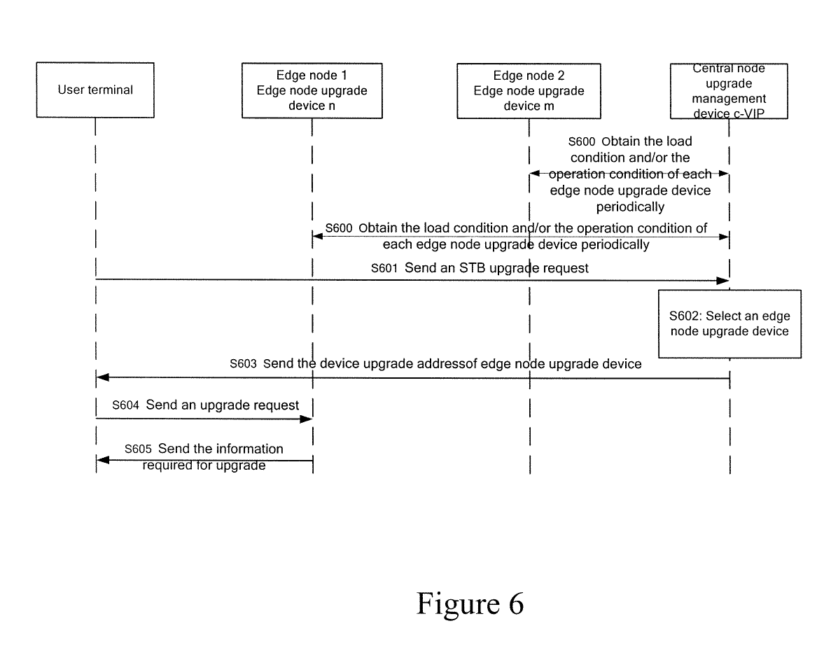

The principle of the above first method is shown in FIG. 5. In a fourth embodiment of the present invention, the central node upgrade management device obtains the load condition and/or the operation condition of each current edge node by exchanging information with each edge node upgrade device periodically. After receiving an STB upgrade request from the user terminal, the central node upgrade management device returns the device upgrade address of an optimized edge node upgrade device as the device upgrade address of the edge node, which is done according to the location of the user terminal, the load condition and/or the operation condition of each current edge node, or preset other strategies. The user terminal upgrades the STB software from the optimized edge node upgrade device according to the device upgrade address received. Referring to the FIG. 6, the signalling flow of the above distributed STB upgrade method includes the following Steps.

s600: A central node upgrade management device performs the signalling interaction with the external network over the load balancing device using one c-VIP address; the central node upgrade management device obtains the load condition and/or the operation condition of each edge node upgrade device from each edge node upgrade device periodically.

s601: The user terminal sends an STB upgrade request to the central node upgrade management device according to the c-VIP address.

s602: The central node upgrade management device determines the location of user terminal as edge node 1. The central node upgrade management device selects an edge node upgrade device whose operation is normal and whose load is the least, according to the load condition and/or the operation condition of n upgrade devices under the edge node 1; or selects a corresponding edge node upgrade device according to the preset other strategies.

s603: The central node upgrade management device sends the address of edge node upgrade device to the user terminal.

s604: The user terminal sends an STB upgrade request to the address of the edge node upgrade device, and records the address as the device upgrade address of the STB. Hereafter the user terminal may send an upgrade request to the address directly instead of sending a request to the central node upgrade management device as long as the user terminal is not rebooted.

s605: An edge node upgrade device sends the information required for the upgrade of the STB to the user terminal; and the user terminal receives the information sent by the edge node upgrade device.

In s601˜s605, if there is a malfunction occurring to the edge node upgrade device which provides the user terminal with the STB upgrade information, the STB reboots the procedure from Step s601 automatically to obtain a new address of the edge node upgrade device.

The second method: a load balancing device is deployed at the front end of each edge node upgrade device group, and the central node upgrade management device notifies the user terminal of taking the address of the load balancing device of the edge node adjacent to the user terminal as the device upgrade address, so the load balancing device implements the load balance and high availability of the distributed edge node upgrade management device group.

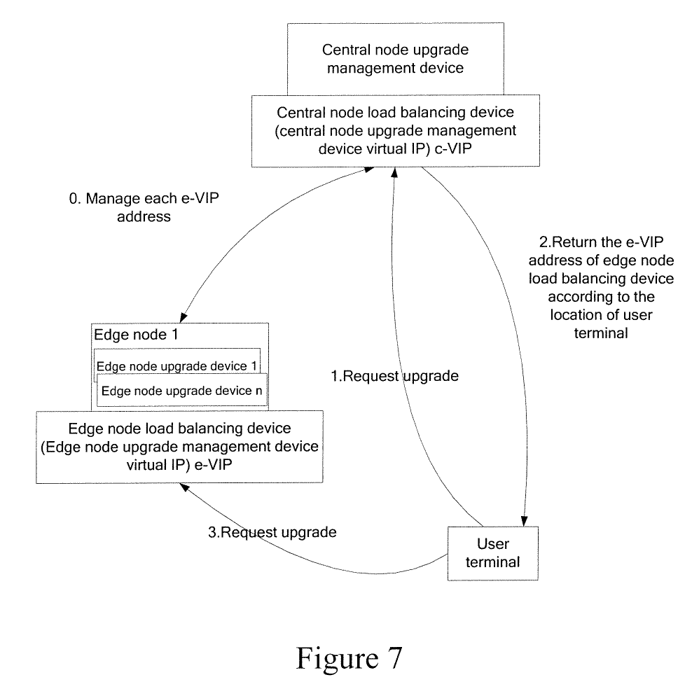

In a fifth embodiment of the present invention, the principle of the above-mentioned second method is shown in FIG. 7. Compared with the Method (1), the Method (2) deploys a load balancing device at the front end of each edge node upgrade device group. The central node upgrade management device directly maintains the location of each user terminal and the e-VIP address of the load balancing device corresponding to the edge node adjacent to the user terminal, and manages the load balancing device of each edge node. The load balancing device of each edge node obtains the load condition and/or the operation condition of each edge node upgrade device, and allocates the traffic of the edge node for the upgrade of the STB. After receiving an STB upgrade request of a user terminal, the central node upgrade management device returns the e-VIP address of the load balancing device of the edge node adjacent to the user terminal to the user terminal; the user terminal sends an STB upgrade request to the e-VIP address of the load balancing device designated, and records the e-VIP address as the device upgrade address of the STB; the edge node load balancing device notifies the edge node upgrade device of sending the STB upgrade information to the user terminal; the edge node upgrade device sends the information required for the upgrade of the STB to the user terminal; the user terminal receives the information.

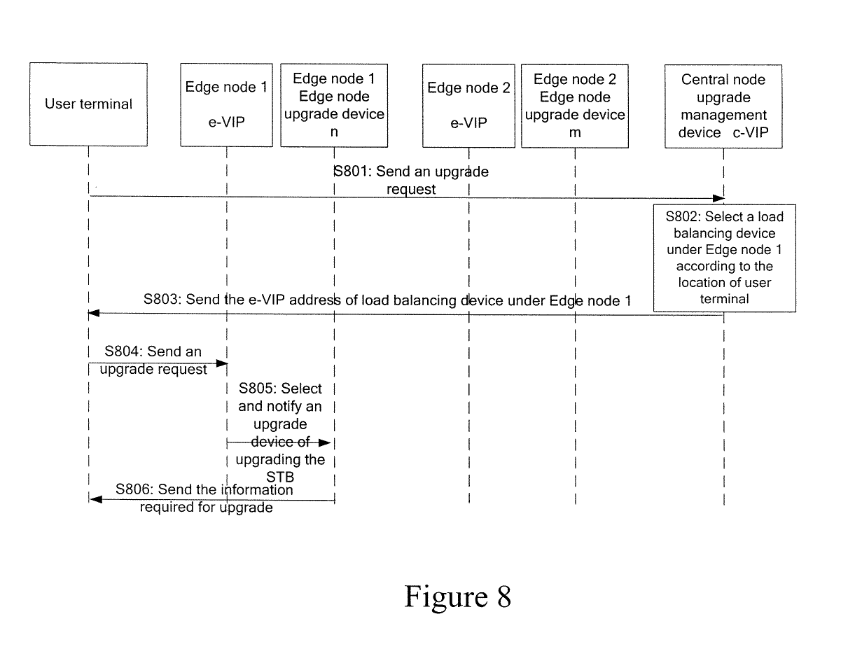

Referring to FIG. 8, the signalling flow of the above distributed STB upgrade method includes:

The central node upgrade management device performs the signalling interaction with the external network over the central node load balancing device using one c-VIP address; an edge node load balancing device is deployed at the front end of each edge node upgrade device group and has an e-VIP address; the central node upgrade management device manages each edge node load balancing device which obtains the load condition and/or the operation condition of each edge node upgrade device periodically.

s801: The user terminal sends an STB upgrade request to the central node upgrade management device.

s802: The central node upgrade management device selects an edge node load balancing device which is under the edge node 1 according to the location of the user terminal, in this embodiment the user terminal is supposed to reside in edge node 1.

s803: The central node upgrade management device sends the e-VIP address of the load balancing device of edge node 1 to the user terminal.

s804: The user terminal sends an STB upgrade request to the e-VIP address of the load balancing device designated, and records the e-VIP address as the device upgrade address of the STB; hereafter, the user terminal may send an upgrade request to the address directly, instead of sending a request to the central node upgrade management device as long as the user terminal is not rebooted.

s805: The edge node load balancing device selects an edge node upgrade device according to the load condition and/or the operation condition of each upgrade device under the edge node, wherein the selection is made according to that the operation of the edge node upgrade device is normal and the load of the edge node upgrade device is least; or selects a corresponding edge node upgrade device according to a preset strategy. Then the edge node load balancing device notifies the edge node upgrade device of sending the STB upgrade information to the user terminal.

s806: The edge node upgrade device sends the information required for the upgrade of the STB to the user terminal; the user terminal receives the information.

In s801˜s806, if there is a malfunction occurring to the edge node load balancing device which provides the user terminal with the STB upgrade information, the STB reboots the procedure from Step s801 automatically to obtain the e-VIP address of a new edge node load balancing device.

In accordance with the methods provided by the fourth embodiment and the fifth embodiment, the central node upgrade management device or the edge node load balancing device selects different edge node upgrade devices as the device upgrade address according to the location of user terminal, the load condition and/or the operation condition of the edge node upgrade device, to obtain the traffic for the upgrade of the STB from the edge node upgrade device directly. According to the fourth embodiment and the fifth embodiment, the pressure to the backbone/convergence network due to the traffic for the upgrade of the STB is greatly reduced, and the response speed and reliability of the upgrade of the STB is improved.

In a sixth embodiment of the present invention, a central node upgrade management device is described. The central node upgrade management device includes a first unit which is configured for receiving an STB upgrade request from a user terminal; a second unit which is configured for selecting a device upgrade address of an edge node; and a third unit which is configured for sending out the device upgrade address of edge node to the user terminal.

The second unit may be configured for selecting the device upgrade address of an edge node upgrade device according to at least one of the location information of the user terminal, the load condition, and the operation condition of each edge node upgrade device deployed in the edge node.

Embodiment of the present invention also provides a computer program product. The computer program product includes computer program code, which, when it is executed by a computer unit, will cause the computer unit to perform the steps of the above mentioned user terminal in the embodiments of the present invention.

Embodiment of the present invention also provides a computer readable medium which stores computer program code mentioned in the above computer program product.

The foregoing are only several embodiments of the present invention. The protection scope of the present invention, however, is not limited to the above description. Any change or substitution, within the technical scope disclosed by the present invention, easily occurring to those skilled in the art should be covered by the protection scope of the present invention as illustrated in the accompanying claims.

What is claimed is:

1. A method for upgrading a distributed Set Top Box, STB, comprising:
receiving an STB upgrade request sent by a user terminal;
selecting a device upgrade address of an edge node; and
sending the device upgrade address of the edge node to the user terminal.

2. The method of claim 1, wherein the user terminal obtains upgrade information from the edge node through the device upgrade address.

3. The method of claim 1, further comprising: obtaining at least one of a load condition and an operation condition of each edge node upgrade device deployed in the edge node, before receiving the STB upgrade request.

4. The method of claim 3, wherein the selecting a device upgrade address of an edge node comprises:
selecting the device upgrade address according to at least one of location information of the user terminal, the load condition, and the operation condition of each edge node upgrade device deployed in the edge node.

5. The method of claim 1, wherein the device upgrade address of the edge node comprises a device upgrade address of an edge node upgrade device deployed in the edge node.

6. The method of claim 5, wherein the user terminal obtains upgrade information from the edge node upgrade device through the device upgrade address.

7. The method of claim 1, wherein the device upgrade address of the edge node comprises a device upgrade address of an edge node load balancing device deployed in the edge node.

8. The method of claim 7, further comprising:
receiving, by the edge node load balancing device, the STB upgrade request sent by the user terminal;
selecting, by the edge node load balancing device, an edge node upgrade device of the edge node upgrade devices deployed in the edge node;
notifying, by the edge node load balancing device, the selected edge node upgrade device of sending the STB upgrade information to the user terminal.

9. The method of claim 8, further comprising: obtaining, by the edge node load balancing device, at least one of a load condition and an operation condition of each edge node upgrade device deployed in the edge node, before receiving the STB upgrade request.

10. A system for upgrading distributed Set Top Box, STB, comprising a central node upgrade management device and at least one edge node, wherein the central node upgrade management device is configured to select an device upgrade address of an edge node and send out the device upgrade address of the edge node to a user terminal upon receiving an STB upgrade request from the user terminal; and
the edge node is configured to send information stored for upgrading an STB to the user terminal upon receiving an upgrade request sent by the user terminal according to the device upgrade address of the edge node.

11. The system of claim 10, wherein each edge node comprises at least one edge node upgrade device which is configured to send information stored for upgrading the STB to the user terminal upon receiving the upgrade request sent by the user terminal according to the device upgrade address of the edge node.

12. The system of claim 11, wherein the central node upgrade management device further comprises a central node load balancing device which is configured to manage a signalling interaction between the central node upgrade management device and an external network, and obtain at least one of the load condition and the operation condition of each edge node upgrade device, and that the central node upgrade device is configured to select the device upgrade address of one edge node upgrade device deployed in the edge node according to at least one of the load condition and the operation condition of the each edge node upgrade device.

13. The system of claim 11, wherein each edge node further comprises an edge node load balancing device which is configured to obtain at least one of the load condition and the operation condition of each edge node upgrade device, to select the device upgrade address of one edge node upgrade device deployed in the edge node according to at least one of the load condition and the operation condition of the each edge node upgrade device, and to notify the selected edge node upgrade device to send the STB upgrade information to the user terminal.

14. The system of claim 13, wherein the central node upgrade management device is configured to select the device upgrade address of the edge node load balancing device as the device upgrade address of the edge node, and send the device upgrade address of the edge node load balancing device to the user terminal upon receiving an STB upgrade request sent by the user terminal.

15. A central node upgrade management device, comprising a first unit, configured to receive a Set Top Box, STB, upgrade request from a user terminal, further comprising:
a second unit, configured to select a device upgrade address of an edge node; and
a third unit, configured to send the device upgrade address of the edge node to the user terminal.

16. The central node upgrade management device of claim 15, wherein the second unit is configured to select the device upgrade address of an edge node upgrade device according to at least one of location information of the user terminal, the load condition, and the operation condition of each edge node upgrade device deployed in the edge node.

17. An edge node in a system for upgrading a distributed Set Top Box, STB, wherein the edge node is configured to receive a STB update request form a user terminal to a device upgrade address of the edge node, and to send the STB user information to the user terminal.

18. The edge node of claim 17, wherein the edge node comprises at least one edge node upgrade device which is configured to send information stored for upgrading the STB to the user terminal upon receiving the upgrade request sent by the user terminal according to the device upgrade address of the edge node.

19. The edge node of claim 18, wherein the edge node comprises an edge node load balancing device which is configured to obtain at least one of the load condition and the operation condition of each edge node upgrade device, to select the device upgrade address of one edge node upgrade device deployed in the edge node according to at least one of the load condition and the operation condition of the each edge node upgrade device, and to notify the selected edge node upgrade device to send the STB upgrade information to the user terminal.

20. A user terminal with a Set Top Box, STB, configured to send a request for STB upgrade information to a central upgrade management system, wherein the user terminal is configured;
to receive a device upgrade address to an edge node from the central upgrade management system;
to send the STB upgrade request to the device upgrade address; and
to receive the STB upgrade information from the edge node.

21. A computer program product, comprising computer program code, which, when executed by a computer unit, will cause the computer unit to perform the steps of a user terminal according to claim 20.

22. A computer readable medium, wherein computer program code according to claim 21 is stored on the computer readable medium.
